(19) United States
(12) Patent Application Publication
(10) Pub. No.: US 2012/0307343 A1
(43) Pub. Date: Dec. 6, 2012

(54) ELECTROPHORETIC DISPLAY

(75) Inventors: Chin-Chuan LAI, HSINCHU (TW); Yi-Ching WANG, HSINCHU (TW); Yuan-Chih TSAI, HSINCHU (TW); Chi-Tsan SHEN, HSINCHU (TW); Lee-Tying CHEN, HSINCHU (TW)

(73) Assignee: E INK HOLDINGS INC., HSINCHU (TW)

(21) Appl. No.: 13/471,481

(22) Filed: May 15, 2012

(30) Foreign Application Priority Data
Jun. 3, 2011 (TW) 100119591

(51) Int. Cl. G02F 1/167

(52) U.S. Cl. 359/296

(57) ABSTRACT

Disclosed herein is an electrophoretic display, which includes a first substrate, an electrophoretic layer, a second substrate, a stress controlling layer and an adhesive layer. The first substrate includes at least one active device and at least one pixel electrode electrically coupled to the active device. The electrophoretic layer is disposed above the pixel electrode. The second substrate is disposed above the electrophoretic layer. The stress controlling layer is formed on a lower surface of the second substrate. The adhesive layer is disposed between the surface stressed layer and the electrophoretic layer, and is in contact with the stress controlling layer and the electrophoretic layer. The adhesion between the stress controlling layer and the adhesive layer is about 75% to 125% of the adhesion between the electrophoretic layer and the adhesive layer.

### RELATED APPLICATIONS

This application claims priority to Taiwan Application Serial Number 100119591, filed Jun. 3, 2011, which is herein incorporated by reference.

### BACKGROUND

1. Technical Field

The present invention relates to an electrophoretic display.

2. Description of Related Art

Recently, flexible display devices, electronic papers and electronic books are quickly developed in marketing. Display apparatus such as liquid crystal display devices (LCDs), electrophoretic display devices and electrochromic display devices are employed in these electronic products.

Electrophoretic display devices are advantageous in flexibility, a wide viewing angle and low power consumption as well as the non-necessity of backlights. Therefore, the electrophoretic display device is an important technology for the development of electronic papers.

The electrophoretic display device includes a number of electrophoretic elements, and each of the electrophoretic elements contains a solvent and charged pigment particles suspended therein. When an electrical field is applied, the charged pigment particles move according to the direction of the applied electrical field. This phenomenon is also known as electrophoresis. The moving speed of the charged pigment depends on the strength, direction and distribution of the electrical field as well as the suspension liquid and the concentration of the pigment particles. The principle of the electrophoretic display device is based on the movement of the charged pigment. A pixel of the electrophoretic display may exhibit a certain color by controlling the charged pigment within the pixel, so that the electrophoretic display may display an image. Usually, the density of the solvent is substantially the same as that of the charged pigment particles. Therefore, pigment particles may be kept at the same position for a long period of several minutes to about 20 minutes even through the electrical filed disappeared. Accordingly, it is expected that the electrophoretic display devices have low power consumption. Furthermore, the electrophoretic display does not need a backlight. The image of the electrophoretic display device is meticulous and gentle for the human eyes. Moreover, electrophoretic displays are more cost-effective than LCDs.

Although electrophoretic display devices possess several advantages as described above, electrophoretic display devices suffer the drawback that the uniformity is hard to be well controlled, and this drawback negatively affect the market share. For example, an abnormal image usually appears at the edge of the electrophoretic display device, and this problem impacts the mass production of electrophoretic display devices. Accordingly, there exists in this art a need for an improved electrophoretic display device, which would resolve the above-mentioned problem.

### SUMMARY

An electrophoretic display is provided. The electrophoretic display includes a first substrate, an electrophoretic layer, a second substrate, a stress controlling layer and an adhesive layer. The first substrate includes at least one active device and at least one pixel electrode electrically connected to the active device. The electrophoretic layer is disposed over the pixel electrode. The second substrate is arranged over the electrophoretic layer. The stress controlling layer is disposed on a lower surface of the second substrate. The adhesive layer is disposed between the stress controlling layer and the electrophoretic layer, and in contact with the stress controlling layer and the electrophoretic layer. The adhesion strength between the stress controlling layer and the adhesive layer is about 75% to about 125% of the adhesion strength between the electrophoretic layer and the adhesive layer.

According to one embodiment of the present disclosure, the adhesion strength between the stress controlling layer and the adhesive layer is about 85% to about 115% of the adhesion strength between the electrophoretic layer and the adhesive layer.

According to one embodiment of the present disclosure, the adhesion strength between the stress controlling layer and the adhesive layer is greater than or equal to the adhesion strength between the electrophoretic layer and the adhesive layer.

According to one embodiment of the present disclosure, the stress controlling layer is made of an insulating fluorine-containing polymer. The thickness of the stress controlling layer is about 0.2 μm to about 2 μm.

According to one embodiment of the present disclosure, the electrophoretic layer includes a polyethylene terephthalate (PET) substrate and a plurality of electrophoretic elements disposed on a lower surface of the polyethylene terephthalate substrate, in which the polyethylene terephthalate substrate is in contact with the adhesive layer.

According to one embodiment of the present disclosure, each of the electrophoretic elements is a microcup electrophoretic element or a microcapsule electrophoretic element.

According to one embodiment of the present disclosure, the adhesive layer is made of a photo-curable resin.

According to one embodiment of the present disclosure, the second substrate includes a transparent substrate, a color resist layer and a transparent electrode layer. The color resist layer is disposed on the transparent substrate. The transparent electrode layer disposed on the color resist layer. The stress controlling layer is disposed on the transparent electrode layer.

According to one embodiment of the present disclosure, the active device is a thin film transistor or a metal oxide semiconductor transistor.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 is a cross-sectional view schematically illustrating an electrophoretic display according to one embodiment of the present of the present disclosure;

FIGS. 2A and 2B are cross-sectional views schematically illustrating an electrophoretic display according to a comparative example of the present disclosure; and

FIG. 3 is a cross-sectional view schematically illustrating an electrophoretic display according to another embodiment of the present of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

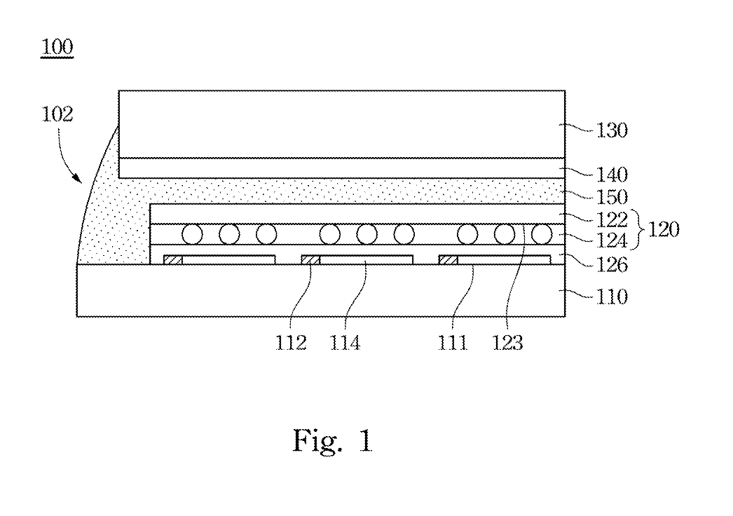

FIG. 1 is a cross-sectional view schematically illustrating an electrophoretic display 100 according to one embodiment of the present of the present disclosure. The electrophoretic display 100 includes a first substrate 110, an electrophoretic layer 120, a second substrate 130, a stress controlling layer 140 and an adhesive layer 150.

The first substrate 110 includes at least one active device 112 and at least one pixel electrode 114. As depicted in FIG. 1, the active device 112 and the pixel electrode 114 may be formed on an upper surface 111 of the first substrate 110, and the pixel electrode 114 is electrically connected to the active device 112. In a transmitting-type display device, the pixel electrode 114 may be formed by transparent conductive material such as indium tin oxide (ITO), zinc oxide or other transparent conductive material. In a reflective-type display device, the pixel electrode 114 may be formed by opaque metal such as aluminum or the like. The active device 112 may be a thin film transistor or a metal oxide semiconductor transistor, for example. A voltage signal may be transmitted to the pixel electrode 114 through the active device 112, and therefore an electrical field created by the pixel electrode 114 may modulate a displaying state of the electrophoretic layer 120.

The electrophoretic layer 120 is disposed over the pixel electrode 114 of the first substrate 110, and the displaying state of the electrophoretic layer 120 may be modulated in accordance with the electrical field applied thereto. There is no specific limitation on the electrophoretic layer 120 so long as it may exhibit different color or different optical property. In one example, the electrophoretic layer 120 may include a plurality of electrophoretic elements 124 and a polyethylene terephthalate (PET) substrate 122. The electrophoretic element 124 may be a microcup electrophoretic element or a microcapsule electrophoretic element. These electrophoretic elements 124 may be disposed on a lower surface 123 of the polyethylene terephthalate substrate 122. Therefore, the polyethylene terephthalate substrate 122 is in contact with the adhesive layer 150 positioned there above. In another example, the electrophoretic layer 120 is adhered to the first substrate 110 by a glue layer 126.

The second substrate 130 is disposed over the electrophoretic layer 120. The second substrate 130 may be a transparent substrate made of glass or other transparent materials. In one example, the electrophoretic display 100 is a reflective-type display device. An incident light may be transmitted to the electrophoretic layer 120 through the second substrate 130, and then the incident light may be reflected out of the electrophoretic display 100 through the second substrate 130 by the reflection of the electrophoretic elements 124 of the electrophoretic layer 120. Therefore, a user may observe the image of the electrophoretic display 100 from the side of the second substrate 130. It is noted that a transmitting-type display device may be employed in the present disclosure as well. In one example, the second substrate 130 may include a glass substrate and a transparent electrode layer formed on a surface of the glass substrate.

The stress controlling layer 140 is disposed on a lower surface of the second substrate 130, and is in contact with the adhesive layer 150. Therefore, the second substrate 130 is not in contact with the adhesive layer 150. In one example, the stress controlling layer 140 is made from an insulating fluorine-containing polymer. The thickness of the stress controlling layer may be about 0.2 μm to about 2 μm. In this example, the stress controlling layer 140 may be formed by coating a layer of polymer solution on the second substrate 130, in which the polymer solution contains the fluorine-containing polymer. Conventional coating methods such as spin coating may be used. After the coating process, the polymer solution layer is cured and transformed into the stress controlling layer 140 by a baking process at a high temperature. After the stress controlling layer 140 is formed on the second substrate 130, the stress controlling layer 140 is bonded with the electrophoretic layer 120 by the adhesive layer 150.

The adhesive layer 150 is disposed between the stress controlling layer 140 and the electrophoretic layer 120, and the adhesive layer 150 is in contact with the electrophoretic layer 120 and the stress controlling layer 140. The adhesive layer 150 is used for adhering the electrophoretic layer 120 to the stress controlling layer 140 formed on the second substrate 130, so that the first substrate 110, the electrophoretic layer 120, the second substrate 130, the stress controlling layer 140 and the adhesive layer 150 are bonded together and thus forming a sealed packaging structure. In this embodiment, the adhesion strength between the stress controlling layer 140 and the adhesive layer 150 is about 75% to 125% of the adhesion strength between the electrophoretic layer 120 and adhesive layer 150. Preferably, the adhesion strength between the stress controlling layer 140 and the adhesive layer 150 is about 85-115% of the adhesion strength between the electrophoretic layer 120 and adhesive layer 150. In one example, the adhesion strength between the stress controlling layer 140 and the adhesive layer 150 substantially equals the adhesion strength between the electrophoretic layer 120 and the adhesive layer 150. In another example, the adhesion strength between the stress controlling layer 140 and the adhesive layer 150 is slightly greater than the adhesion between the electrophoretic layer 120 and the adhesive layer 150. The adhesive layer 150 may be made of a photo-curable resin such as a UV curable resin. In one example, the adhesive layer 150 further covers and surrounds an outer edge 102 of the electrophoretic display 100 to enhance the adhesive strength between the first substrate 110 and the second substrate 130 and prevents moisture and contaminants from reaching the inside of the electrophoretic display 100.

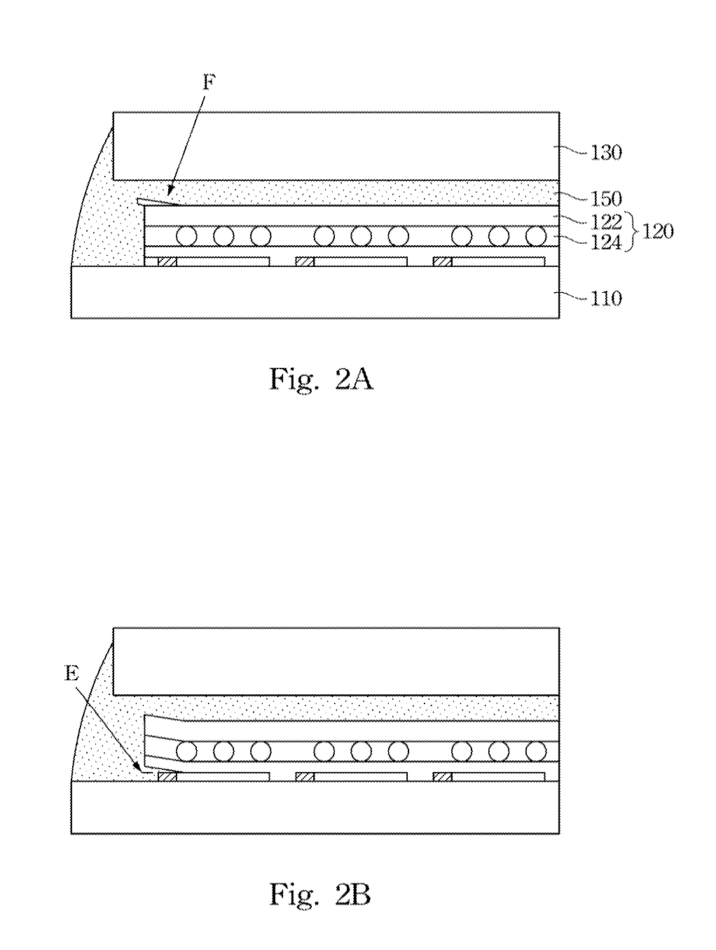

The relationship of the adhesions strength described above is important. FIG. 2A is a cross-sectional view schematically illustrating an electrophoretic display according to a comparative example of the present disclosure. In this comparative example, the second substrate 130 is a glass substrate. The adhesive layer 150 is made of a UV-curable resin. The substrate 122 of the electrophoretic layer 120 is made of PET. It is noted that the comparative electrophoretic display does not include any stress controlling layer 140, and thus the second substrate 130 is in contact with the adhesive layer 150. In other words, the second substrate 130 is directly adhered to the electrophoretic layer 120 by the adhesive layer 150. In this comparative example, after the adhesive layer 150 is irradiated and cured by a UV light, a portion of the adhesive layer 150 is peeled off from the electrophoretic layer 120, especially at the edge of the electrophoretic display 100 as indicated by arrow F in FIG. 2A. Therefore, the light path through the peeled region differs from that of the normal region, and therefore the peeled region may not appropriately display an image. In a worse case, the electrophoretic layer 120 is peeled from the first substrate 110 at the edge of the electrophoretic display 100, and a portion of the adhesive layer 150 penetrates into the interface between the electrophoretic layer 120 and the first substrate 110 as indicated by arrow E in FIG. 2B. Accordingly, the peeled region in the electrophoretic display 100 may not appropriately display an image.

In order to resolve the above-mentioned issue, the inventor of the present disclosure made a lot of efforts in modifying process conditions and changing the material of the adhesive layer. However, the problem may not completely be resolved. The inventor of the present disclosure discovers that conventional adhesive materials exhibit a stronger adhesion with glass substrate than with other substrate. Specifically, the adhesion strength between the adhesive layer 150 and a glass substrate is 1.5 fold of that between the adhesive layer 150 and a PET substrate. In a testing example, the adhesion strength between the adhesive layer 150 and a glass substrate is about 30 Kg, whereas the adhesion strength between the adhesive layer 150 and the PET substrate 122 is only about 20 Kg, measured at the same condition. The adhesion strength between the adhesive layer 150 and the second substrate 130 is significantly greater than the adhesion strength between the adhesive layer 150 and the PET substrate 122 of the electrophoretic layer 120. When the adhesive layer 150 is irradiated and cured by UV light, the adhesive layer 150 is shrunk in volume, and exhibits a significant difference in adhesion strength between the glass substrate and the PET substrate such that a portion of adhesive layer 150 is peeled off from the electrophoretic layer 120.

According to one embodiment of the present disclosure, the stress controlling layer 140 is formed on a surface of the second substrate 130 such that the adhesion strength between the stress controlling layer 140 and the adhesive layer 150 is about 75% to about 125% of the adhesion strength between the electrophoretic layer 120 and the adhesive layer 150. Therefore, the above-mentioned problem is resolved.

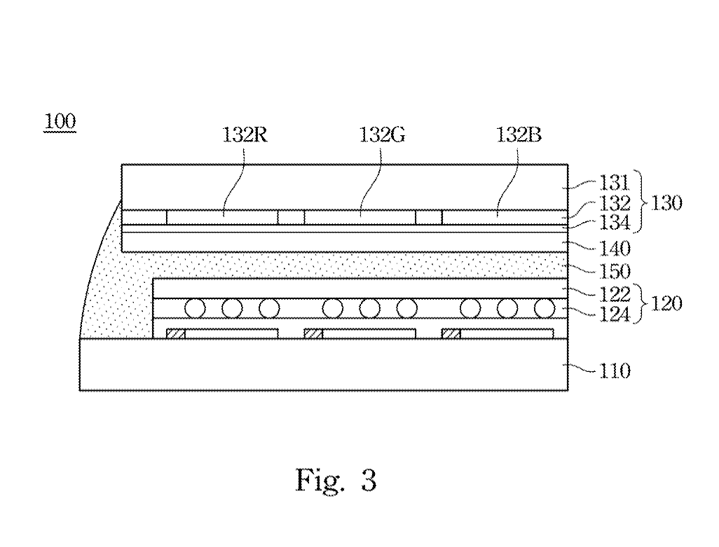

FIG. 3 is a cross-sectional view schematically illustrating an electrophoretic display 100 according to another embodiment of the present of the present disclosure. In this embodiment, the electrophoretic display 100 has a structure similar to the structure of the embodiment depicted in FIG. 1, except that the second substrate 130 includes a transparent substrate 131, a color resist layer 132 and a transparent electrode layer 134. The color resist layer 132 is disposed on an inner surface of the transparent substrate 131 for providing a colorful image. In particular, the color resist layer 132 includes a plurality of patterned red resist 132R, a plurality of patterned green resist 132G and a plurality of patterned blue resist 132B. Each of the color resist regions 132R, 132G, 132B is corresponding to a pixel electrode 114. Therefore, the electrophoretic display 100 may display a full color image. The transparent electrode layer 134 is disposed on the color resist layer 132. The displaying state of the electrophoretic element 124 may be modulated and controlled by the electrical filed created between the transparent electrode layer 134 and the pixel electrode 114. In this embodiment, the stress controlling layer 140 is disposed on a lower surface of the transparent electrode layer 134. The stress controlling layer 140 is in contact with the adhesive layer 150. In other embodiment, the electrophoretic display 100 may be an In-Plane-Switching (IPS) display device, and therefore the transparent electrode layer 134 formed on the color resist layer 132 is no longer required. In this case, the stress controlling layer 140 may be disposed on the color resist layer 132.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An electrophoretic display, comprising:
a first substrate having at least one active device and at least one pixel electrode electrically connected to the active device;
an electrophoretic layer disposed over the pixel electrode;
a second substrate arranged over the electrophoretic layer;
a stress controlling layer disposed on a lower surface of the second substrate; and
an adhesive layer disposed between the stress controlling layer and the electrophoretic layer, and in contact with the stress controlling layer and the electrophoretic layer;
wherein an adhesion strength between the stress controlling layer and the adhesive layer is about 75% to about 125% of an adhesion strength between the electrophoretic layer and the adhesive layer.

2. The electrophoretic display according to claim 1, wherein the adhesion strength between the stress controlling layer and the adhesive layer is about 85% to about 115% of the adhesion strength between the electrophoretic layer and the adhesive layer.

3. The electrophoretic display according to claim 1, wherein the adhesion strength between the stress controlling layer and the adhesive layer is greater than or equal to the adhesion strength between the electrophoretic layer and the adhesive layer.

4. The electrophoretic display according to claim 1, wherein the stress controlling layer is made of an insulating fluorine-containing polymer.

5. The electrophoretic display according to claim 1, wherein the stress controlling layer has a thickness of about 0.2 μm to about 2 μm.

6. The electrophoretic display according to claim 1, wherein the electrophoretic layer comprises a polyethylene terephthalate (PET) substrate and a plurality of electrophoretic elements disposed on a lower surface of the polyethylene terephthalate substrate, and the polyethylene terephthalate substrate is in contact with the adhesive layer.

7. The electrophoretic display according to claim 6, wherein each of the electrophoretic elements is a microcup electrophoretic element or a microcapsule electrophoretic element.

8. The electrophoretic display according to claim 1, wherein the adhesive layer is made of a photo-curable resin.

9. The electrophoretic display according to claim 1, wherein the second substrate comprises:
a transparent substrate:
a color resist layer disposed on the transparent substrate; and
a transparent electrode layer disposed on the color resist layer;
wherein the stress controlling layer is disposed on the transparent electrode layer.

10. The electrophoretic display according to claim 1, wherein the active device is a thin film transistor or a metal oxide semiconductor transistor.
